(19) United States
(12) Patent Application Publication
(10) Pub. No.: US 2015/0121308 A1
(43) Pub. Date: Apr. 30, 2015

(54) USER TERMINAL, INTERFACE ICON UPDATING SYSTEM AND INTERFACE ICON UPDATING METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEI ZHONG, Shenzhen (CN); CHIH-SAN CHIANG, New Taipei (TW); HUA-DONG CHENG, Shenzhen (CN); LING-JUAN JIANG, Shenzhen (CN)

(21) Appl. No.: 14/498,015

(22) Filed: Sep. 26, 2014

(30) Foreign Application Priority Data
Oct. 31, 2013 (CN) 2013105259446

(51) Int. Cl. G06F 3/0481; G06F 3/0482

(52) U.S. Cl. CPC G06F 3/04817; G06F 3/0482
USPC 715/811

(57) ABSTRACT

An interface icon updating system for updating positions of icons displayed on an interface of a user terminal includes a storage module, a statistics module, a category conformation module, an icon conformation module and an icon replacement module. The storage module stores a relationship between the icons and program categories corresponding to application programs associated with the icons. The statistics module calculates operated times of each icon in a preset period of time. The category conformation module determines the icon operated the most times in the preset period of time, and determines the program category corresponding to the application program associated with determined icon according to the relationship. The icon conformation module determines other icons associated with determined category according to the relationship. The icon replacement module arranges all determined icons at a preset area of the interface. The disclosure also provides an icon updating method.

### FIELD

The present disclosure relates to an user terminal, an interface icon updating system and an interface icon updating method.

### BACKGROUND

In order to quickly find favorite icons on an interface, the favorite icons are manually arranged at a conspicuous area of the interface by a user.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagram block of an interface icon updating system, according to an exemplary embodiment.

FIG. 2 is a flowchart of an interface icon updating method, according to an embodiment.

### DETAILED DESCRIPTION

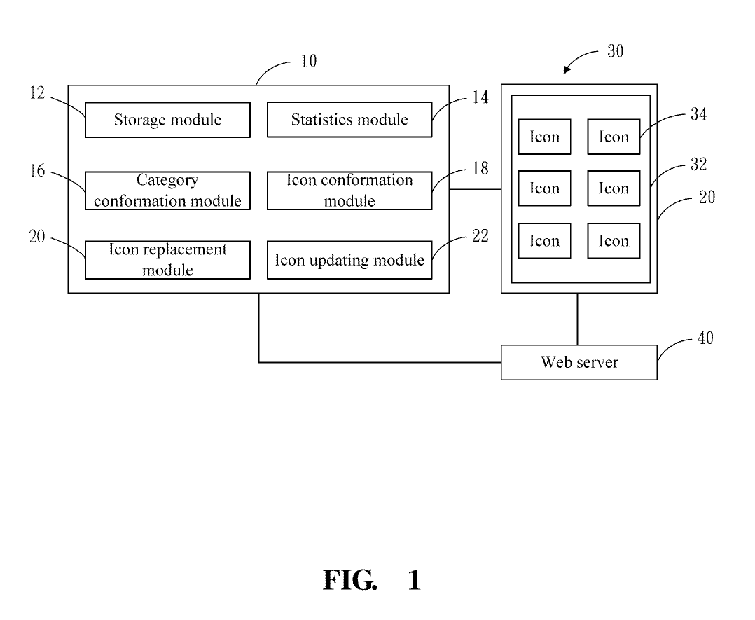

FIG. 1 illustrates an interface icon updating system 10 of an embodiment. The interface icon updating system 10 is employed in a user terminal 30. The user terminal 30 includes a display 20 for displaying icons 34 on an interface 32 of the user terminal 30. The interface icon updating system 10 is configured for updating positions of the icons 34 displayed on the interface 32. The icons 34 are associated with application programs. The icon updating system 10 includes a storage module 12, a statistics module 14, a category conformation module 16, an icon conformation module 18, and an icon replacement module 20.

The storage module 12 is configured to store a relationship between the icons 34 and program categories corresponding to the application programs associated with the icons 34.

The statics module 14 is configured to calculate operated times of each icon 34 in a preset period of time, e.g. three days.

The category conformation module 16 is configured to determine the icon 34 which has operated the most times in the preset period time, and determine the program category corresponding to the application program associated with the determined icon 34 according to the relationship.

The icon conformation module 18 is configured to determine other icons 34 on the interface 32 associated with the determined category according to the relationship.

The icon replacement module 20 is configured to arrange all the determined icons 34 at a preset area of the interface 32, and correspondingly move the icons 34 originally positioned at the preset area to another area of the interface 32. In the embodiment, the preset area is a center area of the interface 32.

The user terminal 30 communicates with a web server 40. The icons 34 associated with the determined category are corresponding to application programs on a web provided by the web server 40. The interface icon updating system 10 further includes an icon updating module 22. The icon updating module 22 is configured to update all the determined icons 34 with new icons 34. The new icons 34 are associated with new application programs, the new application programs are associated with the determined category and are most frequently used on the web. In the embodiment, the icon updating module 22 updates all the determined icons 34 with the new icons 34 in response to a manual operation on the interface 32. In an alternative embodiments, when the user terminal 30 communicates with the web server 40, the icon updating module 22 automatically updates all the determined icons 34 with the new icons 34.

For example, the user terminal 30 displays a number of icons 34 on the interface 32. Three icons 34 of the number of the icons 34 are “Mang Tan”, “Ji Xie Shi” and “Ren Shan Ren Hai”. The application programs associated with the three icons 34 are corresponding to a movie category. The user terminal 30 communicates with a web server 40. The web server 40 provides a movie web. The movie web includes application programs respectively associated with movies “Mang Tan”, “Ji Xie Shi” and “Ren Shan Ren Hai”. After a period time, movies “Shen Du Long Wang”, “Le Fan Tian” and “Di Xin Yin Li” are most frequently used. The icon “Mang Tan” 34 on the interface 32 is determined as an icon operated the most times in the preset period time. The icon updating module 22 updates the icons 34 “Mang Tan”, “Ji Xie Shi” and “Ren Shan Ren Hai” with the new icons 34 “Shen Du Long Wang”, “Le Fan Tian” and “Di Xin Yin Li”. Therefore, the icons 34 are automatically changed in time.

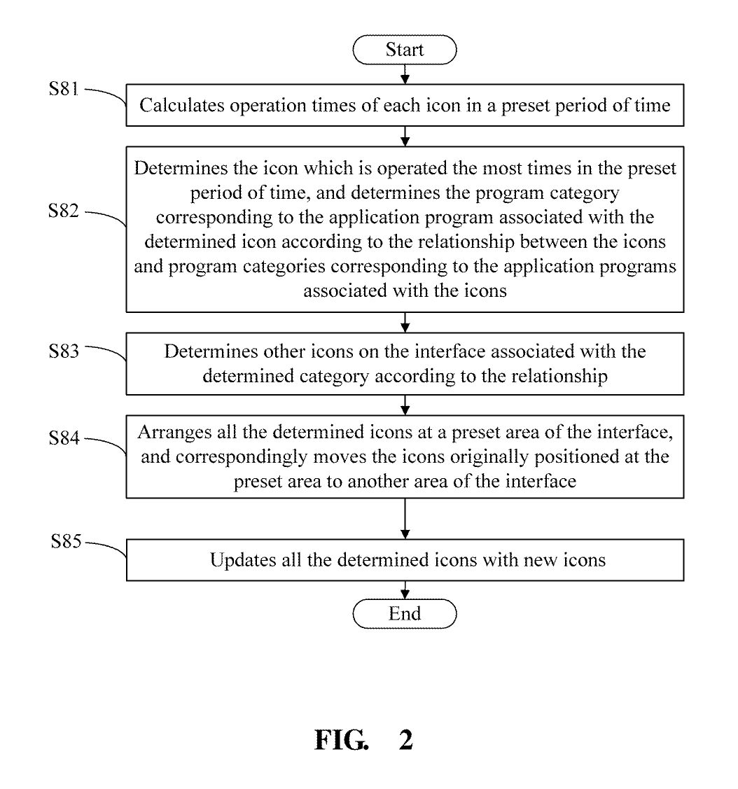

FIG. 2 shows a flowchart of an interface icon updating method. The interface icon updating method is employed to update positions of the icons 34 displayed on the interface 32 of the user terminal 30.

In step S81, the information statics module 14 calculates operation times of each icon 34 in a preset period of time.

In step S82, the category conformation module 16 determines the icon 34 which is operated the most times in the preset period of time. In addition, the category conformation module 16 determines the program category corresponding to the application program associated with the determined icon 34 according to the relationship between the icons 34 and program categories corresponding to the application programs associated with the icons 34.

In step S83, the icon conformation module 18 determines other icons 34 on the interface 32 associated with the determined category according to the relationship.

In step S84, the icon replacement module 20 arranges all the determined icons 34 at a preset area of the interface 32, and correspondingly moves the icons 34 originally positioned at the preset area to another area of the interface 32. In the embodiment, the preset area is a center area of the interface 32.

In step S85, the icon updating module 22 updates all the determined icons 34 with new icons 34. The new icons 34 are associated with the new application programs. The new application programs are associated with the determined category and are most frequently used on a web provided by the web server 40 communicating with the user terminal 30. In the embodiment, the icon updating module 22 updates all the determined icons 34 with the new icons 34 in response to a manual operation on the interface 32. In an alternative embodiment, the icon updating module 22 automatically updates all the determined icons 34 with the new icons 34 when the user terminal 30 communicates with the web server 40.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An interface icon updating system for updating positions of icons displayed on an interface of a user terminal, the interface icon updating system comprising:
a storage module configured to store a relationship between the icons and program categories corresponding to application programs associated with the icons;
a statistics module configured to calculate operated times of each icon in a preset period of time;
a category conformation module configured to determine the icon operated the most times in the preset period of time, and determine the program category corresponding to the application program associated with determined icon according to the relationship;
an icon conformation module configured to determine other icons associated with determined category according to the relationship; and
an icon replacement module configured to arrange all determined icons at a preset area of the interface.

2. The interface icon updating system as claimed in claim 1, wherein the icon replacement module is further configured to move the icons originally positioned at the preset area to another area of the interface.

3. The interface icon updating system as claimed in claim 1, wherein the user terminal communicates with a web server, the icons associated with determined category are corresponding to application programs on a web provided by the web server.

4. The interface icon updating system as claimed in claim 3, wherein the interface icon updating system further comprising an icon updating module, the icon updating module is configured to update all the determined icons with new icons, the new icons are associated with new application programs, the new application programs are associated with the determined category and are most frequently used on the web.

5. The interface icon updating system as claimed in claim 4, wherein the icon updating module updates all the determined icons with the new icons in response to a manual operation on the interface.

6. The interface icon updating system as claimed in claim 4, wherein when the user terminal communicates with the web server, the icon updating module automatically updates all the determined icons with the new icons.

7. The interface icon updating system as claimed in claim 1, wherein the preset area is a center area of the interface.

8. An user terminal comprising:
a display for displaying icons on an interface of the user terminal;
a storage module configured to store a relationship between the icons and program categories corresponding to application programs associated with the icons;
a statistics module configured to calculate operated times of each icon in a preset period of time;
a category conformation module configured to determine the icon operated the most times in the preset period of time, and determine the program category corresponding to the application program associated with determined icon according to the relationship;
an icon conformation module configured to determine other icons associated with determined category according to the relationship; and
an icon replacement module configured to arrange all determined icons at a preset area of the interface.

9. The user terminal as claimed in claim 8, wherein the icon replacement module is further configured to move the icons originally positioned at the preset area to another area of the interface.

10. The user terminal as claimed in claim 8, wherein the user terminal communicates with a web server, the icons associated with determined category are corresponding to application programs on a web provided by the web server.

11. The user terminal as claimed in claim 10, wherein the user terminal further comprising an icon updating module, the icon updating module is configured to update all the determined icons with new icons, the new icons are associated with new application programs, the new application programs are associated with the determined category and are most frequently used on the web.

12. The user terminal as claimed in claim 11, wherein the icon updating module updates all the determined icons with the new icons in respond to a manual operation on the interface.

13. The user terminal as claimed in claim 11, wherein when the user terminal communicates with the web server, the icon updating module automatically updates all the determined icons with the new icons.

14. The user terminal as claimed in claim 8, wherein the preset area is a center area of the interface.

15. An interface icon updating method comprising:
calculating operated times of each icon on an interface in a preset period of time;
determining the icon which is operated the most times in the preset period of time;
determining a program category corresponding to an application program associated with determined icon according to a relationship between the icons and program categories corresponding to application programs associated with the icons;
determining other icons associated with determined category according to the relationship; and
arranging all the determined icons at a preset area of the interface.

16. The interface icon updating method as claimed in claim 15, further comprising
moving the icons originally positioned at the preset area to another area of the interface.

17. The interface icon updating method as claimed in claim 15, wherein the icons associated with determined category are corresponding to application programs on a web.

18. The interface icon updating method as claimed in claim 17, further comprising:
updating all the determined icons with new icons, the new icons are associated with new application programs, the new application programs are associated with the determined category and are most frequently used on the web.

19. The interface icon updating method as claimed in claim 17, further comprising:
automatically updating all the determined icons with new icons, the new icons are associated with new application programs, the new application programs are associated with the determined category and are most frequently used on the web.

20. The interface icon updating method as claimed in claim 17, wherein the preset area is a center area of the interface.
